(19) United States
(12) Patent Application Publication
(10) Pub. No.: US 2009/0177965 A1
(43) Pub. Date: Jul. 9, 2009

(54) AUTOMATIC MANIPULATION OF CONFLICTING MEDIA PRESENTATIONS

(75) Inventors: Evy M. Peralta, Austin, TX (US); Javier R. Torres, Austin, TX (US)

Correspondence Address: IBM AUSTIN IPLAW (DG), C/O DELIZIO GILLIAM, PLLC, 15201 MASON ROAD, SUITE 1000-312, CYPRESS, TX, 77433, US

(73) Assignee: International Business Machines Corporation, Armonk, NY (US)

(21) Appl. No.: 11/969,311

(22) Filed: Jan. 4, 2008

(51) Int. Cl. G06F 3/048

(52) U.S. Cl. 715/716

(57) ABSTRACT

Automatically manipulating presentation of two or more conflicting media contents can prevent intrusive or interruptive presentation of media content. A user can be freed of manually manipulating presentation of media content. The media content is prioritized based on one or more factors, such as predefined user input, location information, metadata about the media content, etc. Subsequently, presentation of the media content is manipulated in accordance with the prioritizing.

### TECHNICAL FIELD

Embodiments of the inventive subject matter generally relate to the field of presenting media content, and, more particularly, to automatic manipulation of conflicting media presentations.

### BACKGROUND

As more and more information becomes digital and accessible, users are encountering situations where multiple streams of data are presented to them at once. This can often happen inadvertently or by choice. For example, a user that is listening to music and browsing through web pages can suddenly have another audio stream start playing at the same time as their music. These overlapping audio feeds require the user to manually intervene and take action to choose the data source which meets the user's priorities. This action can involve manually pausing the music or stopping an embedded audio stream to continue listening to music.

### SUMMARY

Embodiments include a method that automatically resolves conflicts between presentations of media contents of a same type. The method comprises detecting an event that corresponds to the presenting of a first media content on a device. It is determined if a second media content of the same type as the first media content is currently playing on the device. Information about the first media content and the second media content are determined. A first priority value for the first media content is determined based, at least in part, on the information about the first media content. A second priority value for the second media content is determined based, at least in part, on the information about the second media content. Presentation of one or both of the first and second media contents is manipulated based, at least in part, on the first and second priority values.

### BRIEF DESCRIPTION OF THE DRAWINGS

The present embodiments may be better understood, and numerous objects, features, and advantages made apparent to those skilled in the art by referencing the accompanying drawings.

FIG. 1 illustrates an example of automatic manipulation of conflicting media content presentations within an operating system.

FIG. 2 depicts a flow diagram of example operations for media presentation conflict resolution.

FIG. 3 illustrates an example media presentation conflict resolution unit.

FIG. 4 depicts an example computer system.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to media within web browsers being manipulated, various embedded and standalone media content players can be manipulated. In other instances, well-known instruction instances, protocols, structures and techniques have not been shown in detail in order not to obfuscate the description.

Automatically manipulating presentation of two or more conflicting media contents can prevent intrusive or interruptive presentation of media content. A user can be freed of manually manipulating presentation of media content. The media content is prioritized based on one or more factors, such as predefined user input, location information, metadata about the media content, etc. Subsequently, presentation of the media content is manipulated in accordance with the prioritizing.

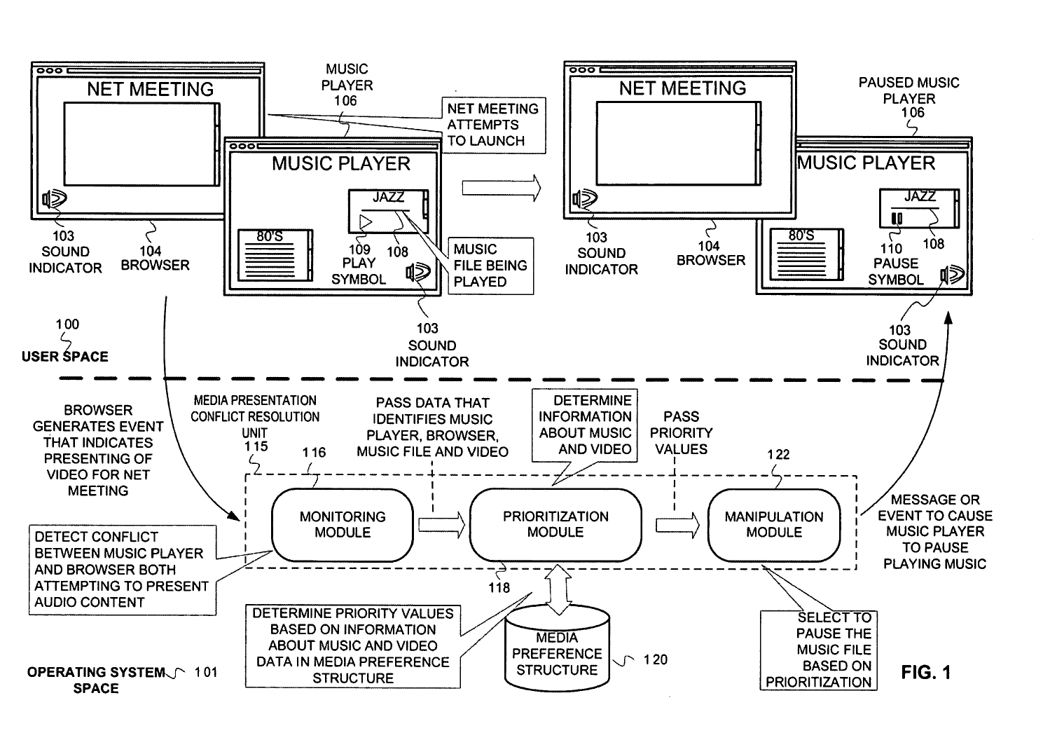

FIG. 1 illustrates an example of automatically manipulating conflicting media content presentations within an operating system. FIG. 1 depicts a user space 100 and an operating system space 101. In this example, user space 100 displays a music player 106 playing a music file 108. Music file 108 is playing, as indicated by a play symbol 109, at an audible volume, as indicated by a sound indicator 103. While the music player 106 plays the music file 108, a browser 104 attempts to launch a net meeting video with audible volume, as indicated by the sound indicator 103. Thus, the browser 104 is attempting to present a same type of media content (audio) as is being presented by the music player 106 in the user space 100.

To present the net meeting, the browser 104 generates an event into the operating system space 101. The event indicates that the browser 104 is attempting to present a video, which includes images and audio. In the operating system space 101, a media presentation conflict resolution unit 115 handles the conflicting presentations of audio. The media presentation conflict resolution unit 115 includes a monitoring module 116, a prioritization module 118, and a manipulation module 122. The monitoring module 116 detects the event generated by the browser 104. After detecting the event, the monitoring module 116 detects a conflict between the music player 106 and the browser 104 because both are attempting to concurrently present audio content. The monitoring module passes data identifying the music player 106, the browser 104, the music file 108, and the net meeting video to a prioritization module 118. For example, the monitoring module 116 determines process identifiers for the music player 106 and the browser 104, as well as references or identifiers for the music file 108 and the video to be presented in the browser 104.

The prioritization module 118 determines information about the music file 108 and the audio content of the video. For instance, the prioritization module 118 examines metadata of the music file 108 and the video. Additionally, the prioritization module 118 can determine information about the music file 108 and the audio content of the video with extraction analysis of the music file 108 and the video. The prioritization module 118 determines priority values based on the determined information about the music file 108 and audio portion of the video, and reading data in a media preference structure 120. The priority values, in this example, are weights associated with various attributes and/or characteristics of the media content as determined from the information. For instance, the prioritization 118 reads metadata for the music file 108 that indicates the music file as music and metadata for the video that indicates the video as a meeting. The media preference structure 120, for example, indicates that a user prefers listening to a meeting over music. The media preference structure 120 represents this preference with a greater weight for media content for a meeting than media content for music. As another example, two competing media contents may both be news audio. Metadata for one news audio stream indicates that the audio stream is financial news and the other audio stream is entertainment news. The media preference structure 120 can indicate that entertainment news has a lower priority value (e.g., weight) than financial news. In another embodiment, priority values may be aggregated. In an example, the media preference structure 120 indicates same priority values for news audio content, but different weights for entertainment media content and finance related media content. The prioritization module 118 reads out the multiple weights and aggregates the weights for each of the audio streams. The prioritization module 118 passes the priority values to a manipulation module 122.

Embodiments can populate the media preference structure 120 with various techniques. For instance, a user, via a graphical user interface, can select a type of media content from a list, and then select certain attributes or characteristics (e.g. work related, educational, financial news, entertainment news, etc.) of the selected type of media content. The selected values may implicit indicate a preference. A user can also assign different values to represent different degrees of preference. For example, a user may select qualifiers (e.g., highly preferred, least preferred, etc.), numerical values, etc.

The media preference structure 120 (or another structure) can also store information about the device that affects the priority values. A system administrator, boot script, etc. configure a device to give reset or modify the priority values to give preference to work related media content over non-work related media content when the device is connected to a work group, a network in a list of networks, etc. Embodiments can configure a device to set or augment priority values to give preference to media content related to legal issues over all other issues.

The manipulation module 122 selects which presentation to interrupt or prevent based on the priority values received from the prioritization module 118. In this example, the manipulation module 122 selects to pause the music player 106 and allow the browser 104 to present the net meeting based on the prioritization values of the media contents. The manipulation module 122 generates a message (e.g., an event or command) that causes the music player 106 to pause the playing of the music file 108.

The user space 100 now displays a paused music player 106. The music file 108 is paused, as indicated by a pause symbol 110. Additionally, the browser 104 has been moved in front of the paused music player 106 to represent activation of the browser 104 or focusing on the browser 104.

Although the above example depicts three modules within the media presentation conflict unit 115, embodiments can realize the functionality for handling conflicts between media content presentation differently. For example, functionality implemented by the modules 116, 118, and 122 can be implemented as three distinct threads or processes that communicate in accordance with inter-process communication techniques of the operating system. As another example, the functionality for automatically resolving conflicts between media content presentations may be a single process or thread. In addition, the functionality may be wholly or partially realized in the background, although not necessarily within operating system space.

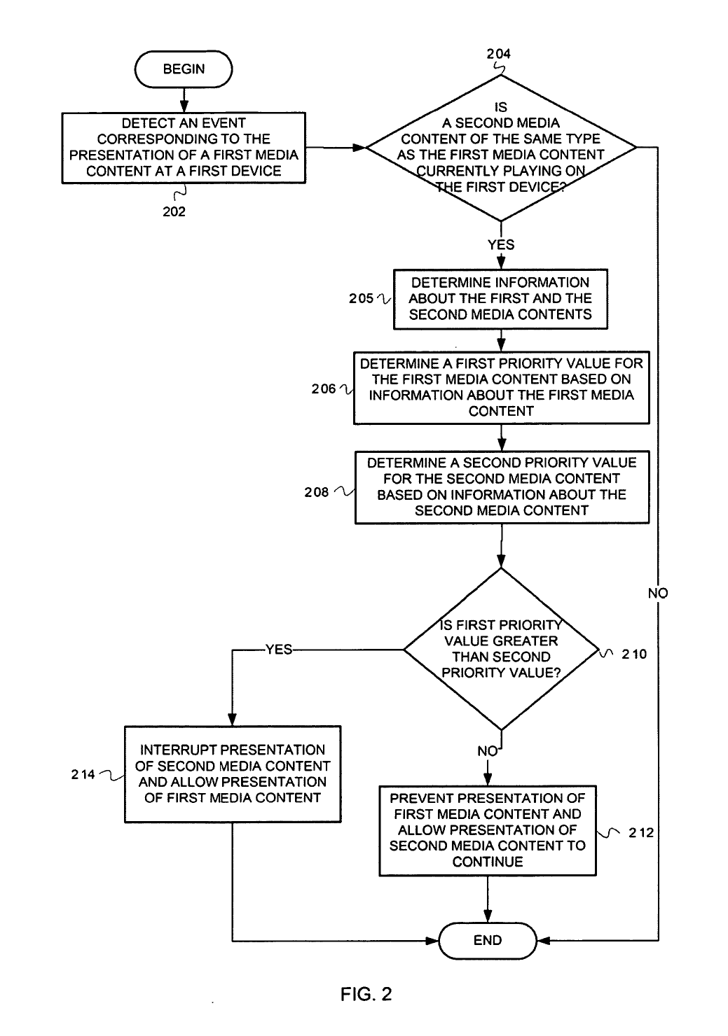

FIG. 2 depicts a flow diagram of example operations for media presentation conflict resolution. At block 202, an event corresponding to the presentation of a first media content at a first device is detected. Examples of the first media content include audio, video, image files, etc. Examples of the first device include a computer, a personal data assistant, a mobile phone, etc. Example techniques for detecting events include monitoring particular media related buffers (e.g., buffers for a sound card or audio chip, buffers for a video card, etc.), monitoring inter-process communications, etc. At block 204, it is determined if a second media content of the same media type as the first media content is currently playing on the first device (e.g., audio and audio, video and video, etc.). For example, a video buffer for a video chip is examined to determine if video data already resides in the buffer as well as new video data from a different process. In another example, a structure is maintained to track processes presenting media content. When an event is detected for presentation of a media content, an entry is created that indicates the process and data about the media content being presented. The structure may have multiple entries (e.g., an entry for audio content being presented, video content being presented, etc.). Before an entry is created, however, the structure is examined to determine if an already existing entry indicates the same type of media content. If the currently playing second media content is not of the same type as the first media content, then control ends. If the currently playing second media content is of the same type as the first media content, then control flows to block 205.

At block 205, information about the first and the second media content is determined. For instance, the media contents are analyzed to determine attributes and/or characteristics about the media contents. As another example, the media contents may have metadata that can be read to determine attributes and/or characteristics about the media contents. At block 206, a first priority value for the first media content is determined based on the information about the first media content. At block 208, a second priority value for the second media content is determined based on the information about the second media content. For example, a set of user defined or historically learned priorities and/or preferences are retrieved. To illustrate, it may be learned that the user prefers to mute or push to the background media content characterized as work related and allow presentation of content characterized as entertainment related. As another example, a user can configure via a graphical user interface, for example, a device to give priority to flash media content from a particular website over all other media content. At block 210, it is determined if the first priority value is greater than the second priority value. If the first priority value is greater than the second priority value, then control flows to block 214. If the first priority value is not greater than the second priority value, then control flows to block 212.

At block 212, presentation of the first media content is prevented and presentation of the second media content is continued. For example, the volume of the first media content can be muted or decreased. As another example, the presentation of the first media content can be put into the background. From block 212, control ends.

At block 214, presentation of the second media content is interrupted and presentation of the first media content is allowed. Examples of interruption include muting the volume of the media content, stopping or pausing the media content, decreasing speed of a sequence of images, minimizing a window, etc. From block 214, control ends.

As described above, a tracking structure can be maintained that indicates media content being presented to detect conflicts. If the currently selected media content is to be interrupted, then the corresponding entry may be removed or tagged with a value that indicates the media content and/or the process presenting the media content has been interrupted.

It should be understood that the example operations depicted in FIG. 2 are meant to aid in understanding embodiments, and should not be used to limit embodiments. Embodiments may perform additional operations, fewer operations, different operations, etc. For example, environment information or information about the device may also be taken into account when prioritizing conflicting presentations of media content. Example of environment information include location of a device, owner of a device, time of day, device status, status of peripherals, etc. For instance, priority values may be modified or overridden based on the a device being in a work location. In addition, priorities may be modified or overridden based on headphones being plugged into the device or speakers being plugged into the device.

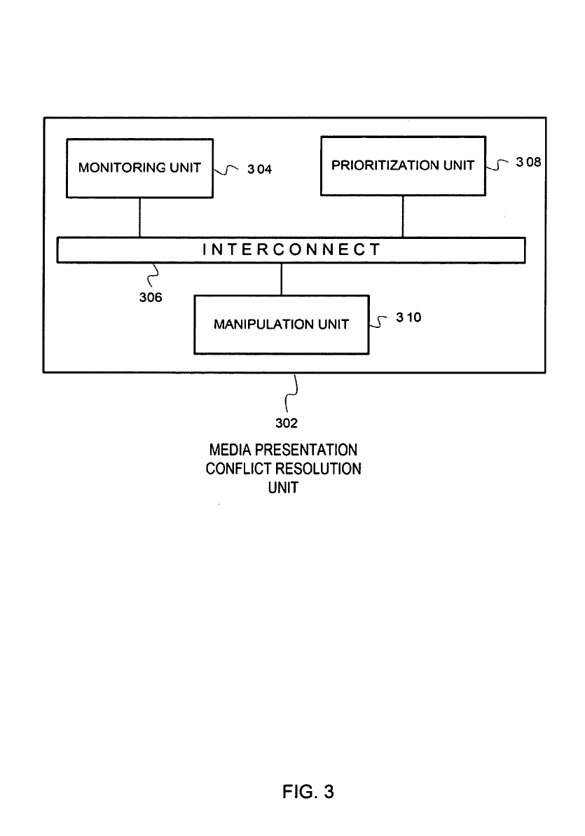

FIG. 3 illustrates an example media presentation conflict resolution unit. A media presentation conflict resolution unit 302 includes a monitoring unit 304, a prioritization unit 308, and a manipulation unit 310. The units 304, 308, and 310 communicate over an interconnect 306.

The monitoring unit 304 is operable to detect a media related event and to identify a process or application that generates the event. Examples of processes or applications that present media content include standalone media players, embedded media players, applets, etc. Additionally, the process can correspond to embedded or separate media players (e.g. web browser player, mp3 player, etc.).

The prioritization unit 308 operates to gather information about the media content and about the environment of the media content. The prioritization unit 308 then uses the information to determine the priority values. As previously mentioned, a set of user defined configurations or historically learned preferences are read. Examples of user defined configurations or learned preferences include a preference to hear news updates versus musical selections, viewing educational content over personal content, etc. Further, the prioritization unit 308 can examine settings in the device to determine information about the device and/or environment (e.g., attached peripherals, location, resource availability, remaining data usage for a mobile phone, etc.).

The manipulation unit 310 operates to select the media content to manipulate based on the prioritization of the media contents by the prioritization unit 308. The manipulation unit 310 can send a message or command to cause increasing, decreasing, or muting of volume, stopping or pausing a presentation, a presentation to no longer be active, increasing or decreasing speed of a presentation, etc.

Although not shown in FIG. 3, the media presentation conflict resolution unit may include other components. Examples of other components include a sound device, a digital-to-analog convertor, etc. In addition, functionality may be realized differently than depicted in FIG. 3. For example, the operations performed by units 308 and 310 may be performed by a single unit. Moreover, the example media presenting manipulation unit 310 may not include the prioritization unit 308 and/or the monitoring unit 304.

The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

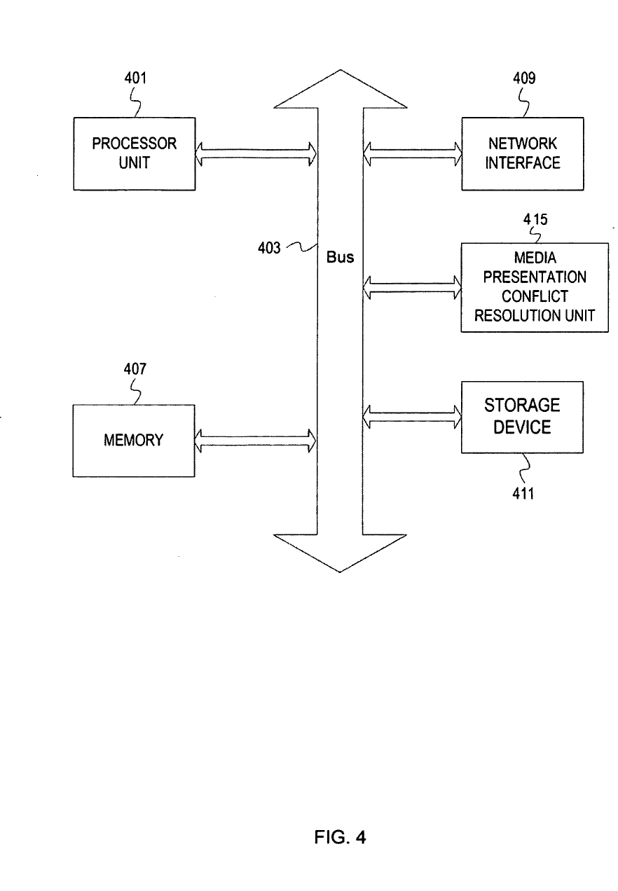

FIG. 4 depicts an example computer system. A computer system includes a processor unit 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport®, InfiniBand®, NuBus, etc.), a network interface 409 (e.g., an ATM interface, an Ethernet interface, a Frame Relay interface, SONET interface, wireless interface, etc.), and a storage device(s) 411 (e.g., optical storage, magnetic storage, etc.). The system also includes a media presentation conflict resolution unit 415, which may be implemented as described above. Some or all of the functionality of the media presentation conflict resolution unit 415 may be implemented with code embodied in the memory and/or processor, co-processors, other cards, etc. Any one of these functionalities may be partially (or entirely) implemented in hardware and/or on the processing unit 401. For example, the functionality may be implemented with an application specific integrated circuit, in logic implemented in the processing unit 401, in a co-processor on a peripheral device or card, etc. Further, realizations may include fewer or additional components not illustrated in FIG. 4 (e.g., video cards, audio cards, additional network interfaces, peripheral devices, etc.). The processor unit 401, the storage device(s) 411, the memory 407, the media presentation conflict resolution unit 415, and the network interface 409 are coupled to the bus 403. Although illustrated as being coupled to the bus 403, all or a portion of the memory 407 may be coupled directly to the processor unit 401.

While the embodiments are described with reference to various implementations and exploitations, it will be understood that these embodiments are illustrative and that the scope of the inventive subject matter is not limited to them. In general, techniques for media presentation conflict resolution as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
detecting an event that corresponds to presenting of a first media content on a device;
determining that a second media content of a same type as the first media content is currently playing on the device;
determining information about the first media content and the second media content;
determining a first priority value for the first media content based, at least in part on the information about the first media content and a second priority value for the second media content based, at least in part, on the information about the second media content; and
manipulating presenting of one or both of the first and the second media contents based, at least in part, on the first and the second priority values.

2. The method of claim 1, further comprising determining information about the device, wherein the first priority value and the second priority value are also based on the information about the device.

3. The method of claim 2, wherein the information about the device comprises at least one of location of the device, owner of the device, time of day, peripheral devices attached to the device, and type of device.

4. The method of claim 1, wherein said determining information comprises at least one of reading metadata of the first media content and analyzing the first media content.

5. The method of claim 1 further comprising maintaining a structure to track processes presenting media content on the device, wherein the structure indicates identifiers of processes and type of media content.

6. The method of claim 1, wherein said manipulating comprises causing at least one of increasing presentation speed, decreasing presentation speed, increasing volume, decreasing volume, pausing, stopping, changing focus of a window presenting one of the first and the second media contents, minimizing a window presenting the one of the first and the second media contents with the lesser priority value, and maximizing a window presenting the one of the first and the second media contents with the greater priority value.

7. The method of claim 1, wherein the type of the first media content comprises one of audio: images, flash, and video.

8. An apparatus comprising:
a set of one or more processor units;
one or more input/output components; and
a media presentation conflict resolution unit operable to detect conflicts between a first process presenting a first media content and a second process presenting a second media content, wherein the first and the second media contents are of a same type of media content, operable to associate a first priority value with the first media content and a second priority value with the second media content, and operable to resolve the conflict based, at least in part, on the associated priority values.

9. The apparatus of claim 8, wherein the media presentation conflict resolution unit is further operable to determine information about the first and the second media contents, wherein the first priority value is based, at least in part on the information about the first media content, and the second priority value is based, at least in part, on the information about the second media content.

10. The apparatus of claim 8, wherein the media presentation conflict resolution unit is further operable to manipulate the first or the second process based, at least in part, on the first and the second priority values.

11. The apparatus of claim 8, wherein the media presentation conflict resolution unit is further operable to determine information about the apparatus, wherein the first priority value and the second priority value are also based on the information about the apparatus.

12. The apparatus of claim 11, wherein the information about the apparatus comprises at least one of location of the apparatus, owner of the apparatus, time of day, peripheral devices attached to the apparatus, and type of apparatus.

13. The apparatus of claim 12, wherein the type of apparatus comprises one of a computer, a mobile phone, a game console, and a personal data assistant.

14. One or more machine-readable media having instructions stored therein which, when executed by a machine cause the machine to perform operations that comprise:
detecting an event that corresponds to presenting of a first media content on a device;
determining that a second media content of a same type as the first media content is currently playing on the device;
determining information about the first media content and the second media content;
determining a first priority value for the first media content based, at least in part on the information about the first media content and a second priority value for the second media content based, at least in part, on the information about the second media content; and
manipulating presenting of one or both of the first and the second media contents based, at least in part, on the first and the second priority values.

15. The machine-readable media of claim 14, wherein the operations further comprise determining information about the device, wherein the first priority value and the second priority value are also based on the information about the device.

16. The machine-readable media of claim 15, wherein the information about the device comprises at least one of location of the device, owner of the device, time of day, peripheral devices attached to the device, and type of device.

17. The machine-readable media of claim 14, wherein said determining information operation comprises at least one of reading metadata of the first media content and analyzing the first media content.

18. The machine-readable media of claim 14, wherein the operations further comprise maintaining a structure to track processes presenting media content on the device, wherein the structure indicates identifiers of processes and type of media content.

19. The machine-readable media of claim 14, wherein said manipulating operation comprises causing at least one of increasing presentation speed, decreasing presentation speed, increasing volume, decreasing volume, pausing, stopping, changing focus of a window presenting one of the first and the second media contents, minimizing a window presenting one of the first and the second media contents, and maximizing a window presenting the one of the first and the second window contents with the greater priority value.

20. The machine-readable media of claim 14, wherein the type of the first media content comprises one of audio, images, flash, and video.
